(19) United States
(12) Patent Application Publication
(10) Pub. No.: US 2009/0174703 A1
(43) Pub. Date: Jul. 9, 2009

(54) PARTICLE-BASED METHOD OF GENERATING AND ANIMATING THREE-DIMENSIONAL VEGETATION

(75) Inventors: DAVID W. HERMANSON, TEMPLE CITY (US); WILLIAM E. KONERSMAN, ALHAMBRA, CA (US)

Correspondence Address: DISNEY ENTERPRISES, INC.;c/o Marsh Fischmann & Breyfogle LLP, 8055 East Tufts Avenue, Suite 450, Denver, CO, 80237, US

(73) Assignee: DISNEY ENTERPRISES, INC., BURBANK, CA (US)

(21) Appl. No.: 11/970,410

(22) Filed: Jan. 7, 2008

(51) Int. Cl. G06T 15/00; G06T 15/70

(52) U.S. Cl. 345/419; 345/473

(57) ABSTRACT

A computer-based method for generating vegetation such as 3D models of trees. The method includes providing in memory a template with model growth rules. A computer processor positions a seed particle in a location in digital 3D space. The base particle is associated with a set of attributes stored in the memory, such as attributes or values provided in the template. A generator module generates the tree model (e.g. a particle system) using a particle-based growth process starting with the seed. The particle growth includes iteratively generating additional particles and also includes gathering environmental data regarding the 3D space for the particles. Then, the method includes determining a move direction for each particle based on the growth rules evaluated with the environmental data The particles are moved to new positions using the move direction, and these steps are continued through time steps to create the tree model.

### BACKGROUND OF THE INVENTION

1. Field of the Invention

The present invention relates, in general, to generating and animating three-dimensional (3D) models of rigid structures such as trees and other vegetation, and, more particularly, to systems and methods for producing computer generated (CG) or computer-animated 3D models of rigid structures such as trees and other vegetation using a particle-based procedure to grow the structure from a starting state or seed state to a user-specified age. The 3D models may be used in creating animated images and animated films or other similar digital works.

2. Relevant Background

Computer animation has become a standard component in the digital production process for animated works such as animated films, television animated shows, video games, and works that combine live action with animation. The rapid growth in this hype of animation has been made possible by the significant advances in computer graphics software and hardware that is utilized by animators to create CG images. Producing computer animation generally involves modeling, rigging, animation, and rendering. First, the characters, elements, and environments used in the computer animations are modeled. Second, the modeled virtual actors and scene elements can be attached to the motion skeletons that are used to animate them by techniques called rigging. Third, computer animation techniques range from key framing animation where start and end positions are specified for all objects in a sequence to motion capture where all positions are fed to the objects directly from live actors whose motions are being digitized. Fourth, computer rendering is the process of representing visually the animated models with the aid of a simulated camera. Modeling is an important aspect of the animation process as it creates models that are used in later steps to provide a desired animation product. Typically, 3D modeling can be labor intensive, require skilled animators or modelers that use both their experience and artistic talent to create models that suit a particular need, and powerful computers to process the large amounts of data involved in generating and animating 3D models.

Modeling has proven particularly difficult for trees and other plants. Generating an accurate 3D model of a tree, for example, can be a very time consuming process, and, as a result, many animated scenes include only a very small number of distinct tree models which are repeated to create a foliage background such as a forest or jungle backdrop. Although it is possible to introduce some perceived variability by incorporating random orientations and textures to the repeated geometric elements, in the end, the visual result is far removed from how a similar collection would appear in nature where each element is distinguished by its own unique form as a result of the complex natural processes that have shaped its growth over time. In addition, a limited repertory of geometric elements may be sufficient for recreating distant foliage but is generally insufficient for mid-ground or foreground trees or other plants if they occur in any number. Although digital sculpting of tree geometry by a skilled 3ID modeler is the best way to produce geometric elements that exhibit the complex and irregular branching structures seen in nature, it is a very labor intensive and expensive process. Some automated tools can generate or grow plants and allow the user to create a wide variety of forms by manipulating input parameters or by choosing from a list of predefined tree species. However, the resulting geometry from these tools cannot match the sophistication of the hand modeled elements, and an additional shortcoming is that these tools grow a single plant in isolation without taking the local topology or growing environment or obstructions into account, e.g., they can generate plants that are relatively accurate for a plant grown in isolation but not in a crowded forest or adjacent to a building or other obstructions such as a boulder, cliff, or other object that would redirect growth of a real plant. As a result, the animation industry is continually searching for tools such as software and graphical interfaces that allow animator to generate and animate 3D models of plants and trees that appear to have been subjected to environmental processes that would occur in nature and affect the growth of the modeled plant or tree. The plant modeling tools preferably would provide a 3D model of a plant whose structure, appearance, and motion would exhibit the same level of organic complexity, variability, and subtlety that is found in their natural counterparts.

Three-dimensional models of plants and trees created with procedural techniques can offer an animator increased modeling control and more efficient modeling than many other techniques. As a result, existing tools or systems typically generate procedural trees using a technique called “L-system-based vegetation growth models” or simply “L-systems.” Because trees are themselves highly complex geometric objects and because both plants and trees can occur in profusion in many scenes, polygonal modeling techniques are generally impractical for modeling all the assets required for producing a realistic rendering in many animation projects. Procedural techniques such as L-systems, on the other hand, attempt to exploit the repeating patterns present in a tree's anatomy as it grows, and thus auto-generate a fairly faithful model of a representative tree form of a given type with minimal artist intervention once the initial growth formula has been defined. Therefore, L-systems embody a structure-oriented procedural technique that is based on the conditions that are internal to the plant, e.g., the growing process of the plant and the resulting structure that is characteristic of a plant species. L-systems express plant growth in terms of mathematical models formalized by biologist Aristide Lindenmayer during the 1960s, and these structure-oriented models describe the growth of plants at the level of cellular interaction. In brief, L-systems work by performing branching procedures to generate successor modules that replace predecessor modules according to a form of a specialized grammar, which users are forced to learn and manipulate to effectively use these tools.

These generative modeling tools grow trees and other plants using a recursive branching structure to provide changes in topology and elongation of existing structures. The resulting regular pattern or 3D model may provide useful results for young trees and plants especially those growing in an unobstructed space such as in the middle of a field. However, L-systems often are less effective for representing mature trees and shrubs that in nature typically have irregularities (e.g., are not symmetric) due to factors such as wind, storm damage, obstacles, and competition for nearby plants for light and space. Some L-system tools are available that allow a user to introduce random variation or noise into the parameter values in an attempt to create trees and plants with better visual realism, but such randomness often will not produce a realistic model and does not account for obstructions and other growth variables. Efforts have been made to model growth parameters such as bud death, competition for space and light for use in controlling bud fate, branch shedding, and tree growth, effects of tropism and gravity on plant growth, but there remains a demand for useful tools for modeling plants such as trees and other objects with rigid bodies.

### SUMMARY OF THE INVENTION

The present invention addresses the above problems by providing vegetation generation methods and systems that use particle-based processes. A particle system is a standard 3D animation paradigm wherein objects (typically amorphous natural phenomena such as fire, fluid or clouds) are represented by a collection of points in 3D space. Each point, or particle, in the collection represents a portion of the whole object and each is assigned a list of attributes to describe the characteristics of that portion. Typically, a particle system is a highly dynamic construct in which any of the number of particles, the particle positions, or the values of each particle's individual attributes can change over time. The present invention's methods and systems employ a particle system representation as a means of describing and generating a 3D model of vegetation (and of other rigid body objects). This particle system representation encompasses all of the structure of the branches and roots of the plant as well as, its flowers and leaves, if present. The plants are grown from a seed or origin state through a number of growth cycles to a user-specified age. Importantly, the growth process is performed for each particle that makes up the plant each growth cycle (e.g., not just for lead nodes at the tips of branches), and the growth or generation process determines and takes into account environmental rules as well as predefined growth parameters/rules from a template. In this manner, the plant is grown under the influence of simulated environmental factors such as light, temperature, wind, and rain as well as, significantly, the influencing factors of physical obstacles and the natural cycles of branching, branch death, and budding. Buds at different locations in the plant (or particles assigned bud attributes) can behave differently (e.g., some being training buds, some being lead buds, some branching, and some acting as trailing buds and also twig growth nodes). If necessary, the 3D model of the plant or the particle base structure for a plant can be manipulated by other tools to selectively (or artistically) modify its structure, and such modification can then be followed by additional growth cycles to create a modified, older plant. The manipulation may also include adding structure or components to the 3D model such as a bark pattern whose directionality reflects the direction of growth of the underlying structure, the adding of twig assemblies, as well as leaves on the twigs, and these additional components may be added with particle-based processes or by other techniques such as L-systems for adding twig assemblies to a subset of the particles forming the base tree structure. The plant or tree thus produced may be very complex and organic in form since they have been influenced during their growth by many of the same natural processes that would have shaped a tree, vine, bush, flower, or other plant grown in nature.

More particularly, a computer-based method is provided for generating rigid geometric models such as a 3D model of a tree or other plant. The method includes providing a template in memory that includes a set of growth rules for the geometric model. A computer processor is used, such as based on user input, to position a base particle or seed/root particle in a location in digital three dimensional space. The base particle is associated with a set of attributes stored in the memory, such as attributes or values provided in the template. The method may continue with running a generator module with the computer processor to generate the geometric model (e.g., a particle system or structure) using a particle-based growth process from the base particle. This particle growth includes iteratively generating additional particles from the base particle and later generated particles (e.g., with at least initial inheritance of attributes from the parent particle). The growth also includes gathering environmental data for the particles (e.g., for all or substantially all of the particles), and, then, determining a move direction for each particle (except the root/seed particle) based on the growth rules as evaluated using the environmental data. The particles are then moved to new positions using the move direction, and these steps are continued through a number of time steps or growth cycles to create the rigid geometric model (e.g., a trunk/branch structure for a tree or the like).

The 3D space may include physical obstacles and the gathered environmental data may include locating or identifying these obstacles and their relative location to each particle (or when they are in proximity to such particles). Ray casting in all directions (e.g., 360 degree space) about the particle may be used to locate the obstacles. The moving step may include determining a direction or selecting a direction that takes the particle away from or around the obstacle (e.g., not into the same space occupied by the object). The gathered environmental data for the particles may also include data on other particles within a predefined proximity (e.g., with a selected radius), and, in this case, the moving may include determining a direction of movement in the 3D space based on this particle proximity information that moves the particle away from other particles or groups of such particles (e.g., to reduce interaction or crowding of particles). The particle-based growth is iterative in that it is repeated for a plurality of time steps or growth cycles and in each cycle, additional particles are generated (e.g., for lead particles or “bud” trailing particles), the environmental data is gathered, and a movement direction is determined and the particles are moved. Hence, the growth is temporal and also is performed on a dynamic basis for each of the particles. The attributes are typically updated in each time step, too, such that this revised and changing information can be used to provide adaptive/changing growth in later time steps or growth cycles (e.g., budding or branching may occur for a particle after a number of time steps, the age of a particle may trigger death, and the like)

In some embodiments, the rigid geometric model is a model of a plant or tree. In these embodiments, the gathering of the environmental data may include measuring tropism effectors and then the moving may include determining a direction of particle movement based on the tropism effectors on a particle-by-particle basis. The particles of a plant may include lead particles and a set of trailing particles for each lead particle, and the gathering of the environmental data and the movement of the particles is performed for both the lead and trailing particles (e.g., at least some of the trailing particles typically move during each growth cycle and not just the lead particles such as due to increased weight of a branch, due to growth that may be different/slower than the lead particle, and the like). Death can be accounted for by having an attribute in the set of each particle that indicates whether the particle is alive or dead, and when dead, the particle may be removed from the model such as after an additional number of growth cycles or time steps (and, typically, all children particles (or the rest of the branch) would also be removed). Some of the particles of a plant or tree typically would be labeled as or provided an attribute indicating they are “bud” nodes and, as such, the particle-based growth may include causing at least some of these bud particles to generate a new lead particle (e.g., after a certain number or a random number of time steps has elapsed as tracked by another attribute) so as to create a new branch.

According to another aspect of the invention, code or logic readable by a computer may be provided on disk, on a hard drive, or other digital data storage device or medium that is useful for generating digital 3D models of plants for use in animation such as creating CG images. The code may be configured to cause a computer to retrieve a set of growth rules for a plant (such as a particular specifies of tree) and providing a set of particles that each have an associated set of attributes including a unique location in a 3D space or growth environment defined within the computer. The code further causes the computer to generate a model of the plant in the 3D space from the set of particles, and this may include performing a predefined number of time steps (or growth cycles). In each time step, the model generating includes gathering environmental data for all or substantially all of the particles including measuring tropism effectors and detecting physical objects in the 3D space. The model generating also include calculating a direction of particle movement for the particles on a particle-by-particle basis including evaluating the growth rules using the gathered environmental data, and then the model generating involves moving the particles to new locations in the 3D space using the calculated direction of particle movement. The detecting of the physical objects includes ray casting from each of the particles, and the direction of particle movement generally will be away from any detected physical objects. The tropism effectors may include a detection of light in the 3D space, and the direction of particle movement will generally be toward such light. The model generating may also account for interaction with other particles (and even other growing trees) with the tropism effectors including particles within a proximity and growing away from crowded areas of the 3D space.

### BRIEF DESCRIPTION OF THE DRAWINGS

FIG. 1 illustrates a functional block diagram of a computer system for generating and animating 3D models of rigid body objects including vegetation such as trees using a particle-based growth process;

FIG. 2 is a flow chart for one exemplary vegetation generation method of the invention such as may be implemented by operation of the system of FIG. 1;

FIG. 3 is an image, such as may be displayed on a user workstation in the system of FIG. 1, of an exemplary tree generated by the particle-based vegetation generation method;

FIG. 4 illustrates the tree of FIG. 3 after an additional number of growth cycles or time steps have occurred resulting in new lead particles, branching from trailing bud nodes or particles, and branching from lead particles;

FIG. 5 illustrates a tree similar to that shown in FIG. 4 but with growth also directed in the opposite direction to provide a root structure with root particles;

FIG. 6 illustrates the particle spline tree or 3D particle tree model of FIG. 4 after a modified tree model is created by enveloping the spline model with a bark or trunk system;

FIGS. 7 and 8 illustrate a front view and a top view, respectively, of a 3D model of a tree such as the tree of FIG. 6 after a plurality of additional growth cycles have occurred, twig systems or assemblies have been attached to some of the branch particles (e.g., via an L-system), and leaves have been attached to ends of the twigs;

FIG. 9 illustrates schematically processes or functions carried out by 3D model generation system of embodiments of the invention showing functionality of the procedural vegetation system and its interaction with an external or additional system/modules; and

FIG. 10 illustrates a 3D model of a particle-based tree grown with the vegetation generation techniques described herein showing particles with attributes that change over time steps as explained with accompanying tabular data and text.

### DETAILED DESCRIPTION OF THE PREFERRED EMBODIMENTS

Briefly, embodiments of the present invention are directed to methods and systems for generating vegetation (or other models for use in animation) using a particle-based growth process (e.g., a growth algorithm). The following description uses the growth of a tree as a representative, but not limiting, example of the underlying features and functions of the invention, but it will be understood that the invention is equally applicable to other vegetation or foliage and also to other 3D modeling that includes a rigid skeleton or the like that can be grown using a particle system. The vegetation generating method grows trees using a particle system with a “particle” or node being a point in space that possesses a number of attributes or qualities. The attributes are used by the method (or a processor implementing such a method or algorithm) to process a set of growth rules (e.g., rules provided by a template that may have default and/or user-selected rules). The rules are evaluated in the method in each frame or growth cycle to determine how to use each particle in the set defining the tree. For example, the method may involve moving particles in each growth cycle or frame to a new position in space and/or updating their attributes with new values.

The particle-based vegetation generator (e.g., software, firmware, and/or hardware in a computer system) acts to store the particles in memory along with their associated attributes. Based on these stored attributes, one kind of particle is called or considered a “lead” particle, node, or bud, and the generator applies a set of leader rules to these particles such that they move toward the light, move away from shade and from other lead particles, move away from wind and/or towards a wall or other wind block, and, in some cases or growth cycles, split into several particles to cause a branch or die. The lead particles leave behind another group of particles called “trail” particles (or given a trail attribute), and trail particles are more stationary. The trail particles are connected together to form splines that are then used by the vegetation generator to form the structure of the tree or a 3D model of the tree.

The set of rules or growth rules can be chosen from a number of sets of rules (e.g., rule sets for various growth environments, for various plant species, and the like) and can also be modified (or default values accepted) via a graphical user interface (GUI). The modified (or accepted) rule set can be saved as a separate text file called a “template.” Once the set of rules for a particular tree species has been established and saved in the set of templates (or set of rule sets) in memory, multiple variants (e.g., multiple models with differing base structure) of the sable “species” can be created by changing rules or parameters such as by changing the random seed, varying the age of the tree (e.g., a forest likely will have trees of many differing ages), or substituting different environmental conditions. Twigs and leaves are placed and oriented, in some embodiments, according to other rules that may be based on the direction of the growth of the tree and a given source of light, and the twigs and leaves may be grown using the particle-based growth algorithm/module or may grown or provided using an L-system or other non-particle system or tool that can work in conjunction with or build upon the base structure or skeleton provided by the set of particles defining the 3D model of the tree (e.g. the particle model can be fed to an external system or other software tool as input for artistic tweaking and editing such as to suit a particular animator's or director's vision or need for a shot). The modified model can then be returned to the particle-based vegetation generator for further growth cycles (e.g., to continue to grow with several branches moved to new positions, removed, or altered in length or shape).

Another usage of the invention is to generate variations of the same tree at different levels of detail (LOD) in the aim of managing complexity in an animation scene. LOD is typically achieved by reducing the number of leaves per twig or number of twigs per branch or the number of branches throughout the whole tree such that the essential overall form is preserved but represented with a lot less geometry. The idea is to generate a 3D model of a tree that is suitably sized for its position and role within a scene. For example, if a particular tree is very far away from the camera, it will very likely be preferable to use a low-resolution version as opposed to one with a very high polygon count.

The process of generating or creating 3D models of elements with rigid skeletons or base structures such as plants and particularly trees will typically be implemented through the use of a computerized workstation with associated software, hardware, and memory for generating, animating, and storing (locally and/or on a networked server or storage device) rule templates, particle sets with attributes, and resulting 3D plant models with or without further modification to include other components useful for animation (such as texturing or bark, twigs, leaves, and the like). Further, the generated models may be used by other software tools and computer systems to create animated images such as by using the 3D models of generated plants or trees to render images for use in compositing and/or animating images for use in an animated film or other work product. Hence, before discussing specific implementations of a particle-based vegetation generation method and representative 3D models that can be produced with this method, it may be useful to describe representative networks, computer systems, storage devices, software, and other tools useful for implementing embodiments of the invention for use by an animator or other end user.

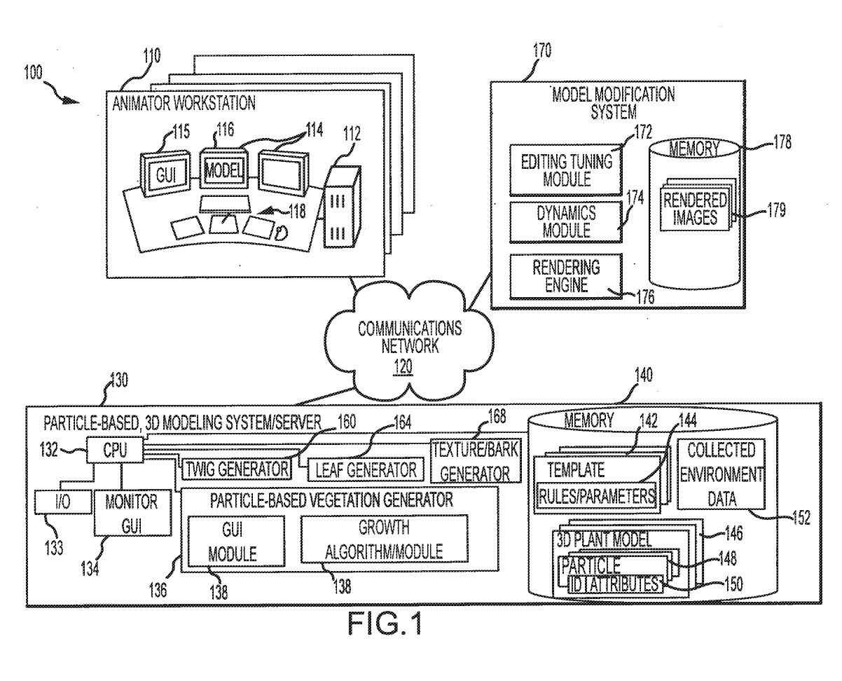

FIG. 1 illustrates an exemplary computer-based system 100 for generating 3D models of objects such as trees and the like that can be modeled using a skeletal or base structure (e.g., a rigid geometric model) that is grown temporally taking into account environmental factors such as obstacles, other portions of the growing object or associated topology, and the like. The system 100 includes one or more animator workstations (or client devices or network nodes) 110 communicatively linked to a particle-based, 3D modeling system 130 via digital communications network 120, e.g., a wired or wireless network such as the Internet, a local area network (LAN), a wide area network (WAN), and the like.

The workstation 110 includes a computer portion 112 such as a 3D graphics processor (e.g., one or more processors or CPUs running graphics and other software/algorithms described herein), hard drives, memory, and software to allow an operator of the workstation 110 to interact with modeling system 130 and perform, in some embodiments, other functions used to create an animated work such as modeling, animation, compositing, and the like (or these may be performed at modeling system 130 or modification system 170). The workstation 110 may be configured to enable a user (e.g., an animator) operating or interacting with a 3D graphics processor, editing modules and monitors, and/or other CG image processing tools such as may be used in animated work productions. In the illustrated exemplary system 100, the 3D modeling system 130 may be accessed and controlled, by a user working at workstation 110 at which the user may access an interactive user interface 115 and created and displayed models 116. The workstation 110 may include multiple monitors 114 and one or more user input mechanisms 118 such as a keyboard, a mouse or trackball, drawing tablet(s), and a drawing pen. The workstation 110 uses processor 112 that provides signals to the monitors 114, controls the visual displays 115, 116 at these monitors 114, and receives and processes user inputs provided to the system via the user input mechanisms 114, e.g., controls the interactive interface or the like. In some embodiments, the interface 115 may be provided to allow an operator to select one or more templates or rule sets for creating a new 3D model such as a new tree model and to alter the rule sets with user input via GUI 115, and the interface 115 also allows a user to initiate use of a particle-based vegetation generator 136 running on system or server 130 (or all or portions of the generator 136 may be run on workstation 110) to grow a new tree or other object based on the selected and, optionally, modified template (e.g., one of the templates 142 in memory 140).

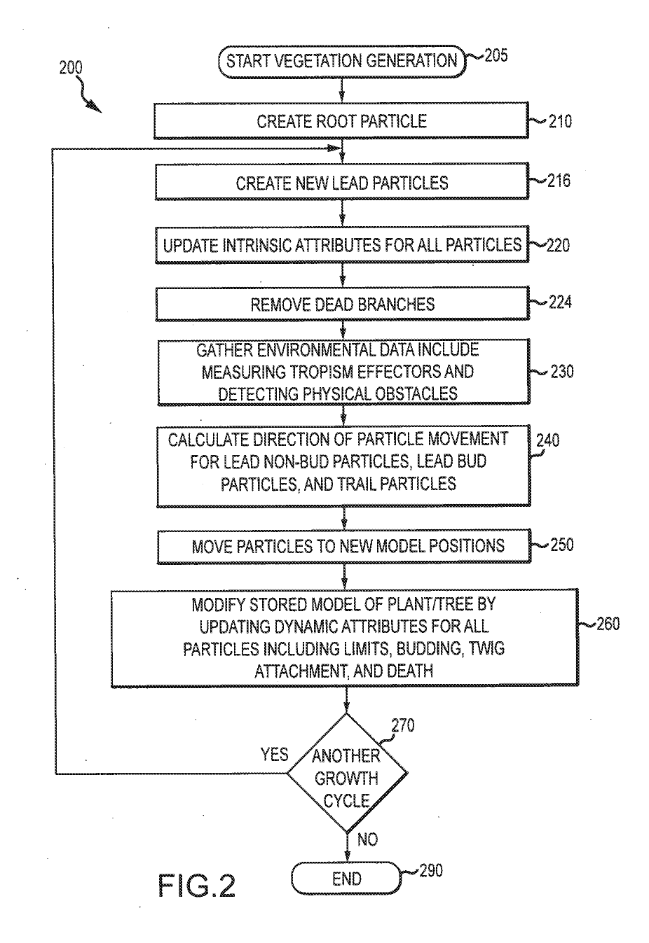

The particle-based, 3D modeling system 130 communicates with the workstation 110 and, in some cases, a model modification system 170 via the network 120. The system 130 may take many forms to practice the invention such as a typical server or computer system/network running software/firmware implementing the processes of the present invention (such as process 200 of FIG. 2). The system 130 is linked to a digital communications network 120 to allow the vegetation generator 136 to be used by workstations 110 on the network 120 and to provide and display user interfaces (e.g., the interface used to select and modify templates 142) and generated or in process 3D plant models 146 (e.g., as models 116 on monitors 114 of workstations 110). The system 130 includes a CPU 132 controlling one or more I/O devices 133 and a monitor or display device 134 such as to allow a user (e.g., an animator, editor, or the like) to use the generator 136 by operating the system 130 (rather than via a workstation 110) to generate vegetation in a particle-based manner and/or to create a number of templates 142 for use by others in creating 3D plant models.

The particle-based vegetation generator 136 is run by the CPU 132 to provide many of the growth and modeling functions described herein (such as performing the generating method 200 of FIG. 2 to create 3D models). To this end, the generator 136 may be provided as software, firmware, hardware, or a combination thereof and/or as code in computer readable media that causes the CPU 132 to effect or perform the described functions. The generator 136 is shown to include a GUI module 137 for generating a user interface such as the UI on monitor 134 and/or the GUI 115 on monitors 114 of the workstation 110 so as to provide a user or operator access to the generator, to select and manipulate templates 142, and to create 3D plant models 146 by beginning from a single seed module and/or from a previously stored model 146. These models may be displayed as shown at 116 on monitors 114, 134 or via user interfaces created by module 137.

The generator 136 also includes a growth algorithm/module 138 for providing particle-based growth of vegetation as described herein. The system 130 includes memory 140 (or data storage may be provided as a separate device such as a component or system accessible via network 120). During operation of the system 130, one or more templates 142 are stored in the memory 140 with each template 142 including a set of rules and/or parameters 144 used by the growth module 138 in growing a tree or other plant using particle system techniques. The 3D plant models 146 generated by the generator 136 are stored in memory 140 and each model 146 is defined by a set of particles or nodes 148. Each particle 146 is labeled or associated with an identification or ID, such as a simple number, and a set of attributes or qualities 150. As explained below, the growth algorithm 138 acts to evaluate each particle 148 of a model 146 during each frame or growth cycle as a plant such as a tree is grown to a particular age, and the attributes 150 are used to determine how the rules 144 of the chosen template need to be enforced or applied to the node or particle 148. For example, a particle 146 may be a bud in a trunk of a tree or a trail particle or it may be a lead particle on a branch or on a twig, and the rules would effect be implemented differently for these differing particles. In each growth cycle (as explained below with reference to FIG. 2), the growth module 138 functions to gather environmental data or environment information for each of these particles such as neighboring particles or proximity of obstacles, and the collected environment data 152 may be temporally stored in, memory 140. The data 152 is used with the attributes 150 for each particle 148 of the modeled tree or plant 146 to evaluate or apply the rules 144 of the applicable template 142. In this manner, each particle is “self-aware” and is processed in each growth step or cycle to generate a complex, realistic tree that is influenced in a temporal and/or ongoing manner by environmental factors.

One benefit of the use of a particle-based generator 136 is that the 3D plant models 146 are created with a rigid structure or skeleton that can be provided as input to other tools or software programs for further manipulation and use. After such manipulation, the modified model can then be returned for further growth processing by the generator 136. For example, the 3D modeling system 130 may also include a twig generator 160 that can be used to generate twigs or twig assemblies on one or more of the particles or buds 148 in the model 146, e.g., on particles with a twig attribute 150. Likewise, a leaf generator 165 may then be used to generate leaves on the end of some or all of the twigs, and a texturing tool or bark generator 168 can be run by CPU 132 to envelope the particle-based skeleton or structure in a skin or bark. These tools may take numerous forms to practice the invention, and in one case, the twig generator 160 used one or more predefined L-systems to grow twig systems or assemblies on the twig-identified particles 146 or on particles selected by an operator of the system 130 or workstation 110.

A model modification system 170 may also take the plant models 146 as input (e.g., via the network 120 or by transfer via a memory device such as a disk, memory stick, or the like). The system 170 may include an editing or tuning module 172 to allow an operator to modify one or more of the 3D plant models 146 such as by adding or deleting grown branches, changing the location or shape of branches, and the like. A dynamics module 174 may be provided to add other characteristics to a model 146 such as characteristics useful for animating a 3D model. A rendering engine 176 may then be used to render the model 146, and the system 170 may include memory 178 for storing rendered images 179 (or the model at any point in the processing by the tools of the system 170) or the modified model 146 may be returned to the system 130 for storage in memory 140 for further growth or use (e.g., stored as a tree or plant of a certain age that can be later be reused as a starting point for a new modeled plant).

Prior to discussing details of a representative generation process, it may be useful to discuss some of the interesting and/or unique features of particle-based vegetation generation and then provide a comparison with existing L-systems. The generation process of embodiments of the invention provides a single particle system or model that can be used to represent trunk, branch, and twig nodes. Each branch and trunk is represented by a single leading particle and multiple trailing particles (or nodes), and during growth or modeling, all particles are evaluated on each iteration of time step (e.g., each growth cycle or frame). In some embodiments, though, the number of evaluated particles may be less than all (such as “substantially all,” which may be thought of as a subset of the particles such as all living buds, a significant fraction such as more than 70 percent of the particles and more typically 90 to 100 percent of the particles) and such subset iterations are considered within the breadth of this description. The generation method supports branch and bud death determinations and responsive updating of the model (e.g., by later having a branch fall off or having a bud stop moving or growing).

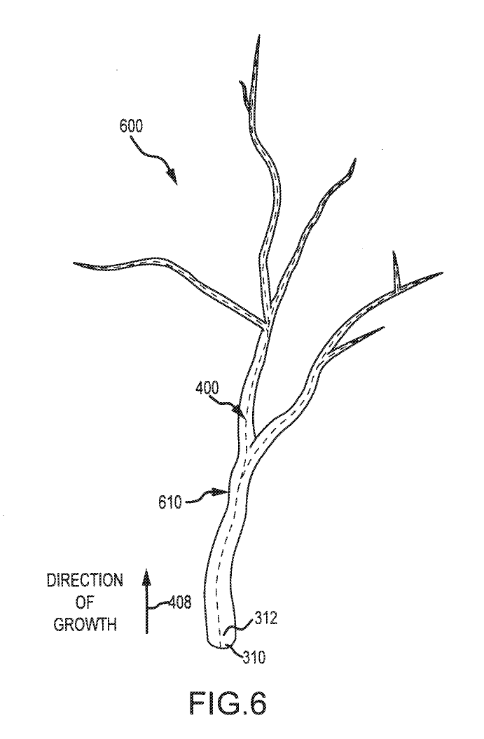

At any point in time, the particles alone can be thought of as defining the topology of a spline skeleton that represents the underlying structure of the tree. However, this skeleton representation is not commonly used as actual output data from the system when creating an animated scene; instead, each particle has an attribute containing the width of the branch at that node as well as additional attributes describing local surface detail. These attributes, which exist on all particles, allow the present invention (or another modeling system) to envelop the points within a 3D geometric surface yielding what is more typically the desired output format (e.g., FIG. 6). By carrying the branch width and additional attributes on each particle, it is possible to construct a closed curve cross section of the branch at each node. These cross sections can then be constituted into a 3D surface by using any standard geometric modeling function such as lofting.

The particle-based method also allows multiple trees to be grown together in proximity with the particles, e.g., their size, shape, and the like, influencing each other (e.g., the environmental data gathering step may include searching for neighboring modeled objects and their particle locations). The growth process responds to other physical objects in the environment such as a tree growth around a fence or wall or growing away from a cliff or the like. The method can be used to create an extremely wide range of tree forms such as evergreens, deciduous, pendulous, and the like and is not suited only for symmetrically or regularly branching young plants. The particle-based method accounts for tropism as growth responds temporally or dynamically to environmental factors such as light, wind, moisture, and the like (e.g., rules and parameters that may be provided via a template and/or in collected environmental data). The method further is effective in varying or more accurately representing growing thickness of trailing particles as, for example, a trunk particle may have a thickness parameter associated with it that is modulated by weight and thicker branches and trunks may have rules applied that cause them to grow more slowly to better simulate nature.

The particle-based method is suited to allow combination with other non-particle plant modeling tools such as those based on L-systems, e.g., for providing a twig hierarchy on particular twig particles or location in the 3D model. The same or a similar growth algorithm may be used in some cases to grow roots. The attributes accumulated for each particle during the growth process may be stored and then used by the other modeling tools, e.g., a bark shader or generator may access the direction of growth attribute for particles in a tree to provide bark textured to better model the growth of the tree. A companion computer system and its software tools may be handshaked or used with the particle-based system and its 3D representations of plants to allow further modification of the plants and their structures after the procedural growth, and such modification typically does not preclude further manipulation of procedural parameters and/or modifying the plant model with further particle-based growth.

Most existing commercial software products that are used by animators to generate trees use a software tool or module(s) called an “L-system,” which works by moving an imaginary turtle forward according to predefined and non-dynamic iterative rules. The L-system simply grows a tree or plant by applying these rules in a iterative manner without regard to the existing and changing environment including other nearby portions of the same or other trees and/or obstacles. Further, use of the particle-based growth tool and its instructions are much clearer and less idiosyncratic than L-systems (e.g., choose and edit a growth template to set rules and/or parameters, position a seed particle in a location or scene that may include other growing plants and/or physical obstacles, and initiate growth for a particular time period or plant age). Unlike L-systems, the methods described herein involve dynamically acquiring information about the environment on a particle-by-particle basis (e.g., the environment for one branch and its particles often will differ from the environment for another branch and its particles within a single plant) and responding accordingly by evaluating the growth rules using this collected data. As in nature, the particle-based generation method reproduces growth functions that include death of portions or all of a plant and, in some cases but not all, regeneration from a previously dead bud or node represented by a particle (e.g., a dead and dormant particle that has not been removed from a tree may later come back to life and again begin to grow in a later time frame or growth cycle). L-systems do not account for death of portions of the plant and later regeneration, and these functionalities of the particle-based method can produce trees or plants that have shapes more likely to be found in nature. The particle-based generator may create, dynamically update in each cycle or frame, and store a nearly unlimited number of attributes for each particle of the model. L-systems generally do not support or provide very limited support for tracking attributes and do not allow the attributes to be changed after they are created. The particle attributes may reflect values useful for other software tools and/or for editing the model to provide a desired result (such as by changing an attribute or a template value during growth of a plant or tree such as growing a tree for 5 years under certain conditions and then changing the conditions and growing it for an additional number of year). The particle attributes may include, for example, the age of a branch, the length of the branch relative to a nearby tree trunk, the distance(s) to nearby objects (such as other tree particles), the vector of the wind at the moment of its birth, and so on.

With reference again to FIG. 1, the operation of the system 100 typically involves a user operating a workstation 110 to access the particle-based, 3D modeling system 130 to grow a tree or other rigid body object including many other plants. Alternatively, the workstation 110 may run the generator 136 with computer 112 or an operator may use the system 130 itself to model a tree or other object. The particular interface (e.g., GUI 115 and UI on monitor 134) may take many forms to practice the invention. Generally, the interfaces along with I/O devices are used to allow a user to take actions necessary to grow a tree and, if desired, to view and/or edit a tree after or during the growth cycles or process. E,or example, a template panel of a user interface may be provided in the GUI that is configured for allowing a user to select one of a number of existing templates 142 or to create a new template. The user may then read the selected template 142 in the GUI, generate variations 142 of the template by altering parameters (such as water, wind, sun, temperature, time between growth cycles, and the like, and saving the several types of data in a new template. The template panel may also allow a user to grow a number of trees with the selected template with, in many cases, at least some of the tree models differing or being variants such as by selecting different growing locations and environments (e.g., one with obstacles or not), differing ages, and the like. These generated 3D models of trees can be saved in memory 140 as shown with element 146.

A grooming panel of the interface may be used after a tree is grown/modeled, and it can be used by an operator to control placement of twigs and leaves such as by selecting particular generators 160, 164 (e.g., calling these routines/tools via the interface) and/or by choosing particular particles or locations in the model 146 for placement (or placement may be automated based on the particle attributes and/or based on the generator chosen). The grooming panel may also be used to call a texture/bark generator 168 to envelope the particle structure or model with a skin or bark, and other parameters may be set or adjusted such as width of the trunk and/or performing small editing such as moving grown branches and the like (e.g., with editing/turning module 172, dynamics module 174, or other modules (not shown)). A custom panel may be provided in the interface with one to many sub-panels that provide controls necessary to design a new plant, e.g., to create a new template 142 based on existing sets of rules/parameters 144 and/or based on user-input rules/parameters.

FIG. 2 illustrates a representative vegetation generation method 200 according to an embodiment of the invention such as may be implemented by operation of the system 100 of FIG. 1. At 205, the method 200 starts such as with loading the particle-based vegetation generator 136 on a server 130, storing one or more templates 142 with rules 142 in memory 140, and accessing the server 130 via a workstation 110. The user may grow a tree, for example, by selecting and loading a template 142, e.g., a template called “startStraight,” that has directional, randomization, and limitation parameters turned to “off” so as the user can understand the results of fundamental controls. In a template panel of a user interface, the user may, select or request to display points to view particles being grown and then set an age in a template field. The “age” may represent frames or growth cycles or, in some cases, it may refer to years (or these two may be related with a growth cycle providing about a year's worth of growth).

The growth process 200 can then be launched or initiated in a number of ways. The user interface may include a “generate tree” button or the like that a user can select, and a growth or simulation 200 will be run without updating the display of the model until it is done. This is a fast technique, but it is not as instructive as watching the tree grow during the process. Another button may be a “play” button, and in this case, the process 200 is initiated for the chosen template with the display showing a tree-like structure formed of dots representing each particle. The structure typically will have relatively straight branches (due to the control settings) and color may be used to show lead particles and trailing particles (e.g., blue dots may be used for lead particles and trailing particles may be shown on a graduated scale from red to green to indicate their trailing status and their age). The interface typically will provide various display options to view the generated 3D model of the tree such as side views (front, back, left, right), top views, bottom views, and the like. Idle generated or grown model may be exported by transferring the model to memory (e.g., a particular folder in memory 140 as a model 146) and, likewise, the template can be stored as shown at 142, if it was changed during the modeling 200.

A more custom tree can be grown with process 200 by using the interface to change or alter a selected template. For example, the interface may allow a template to be selected and retrieved and then provide controls to modify template rules/parameters 144. In some cases, a user may select branch or branching rules and the length parameters. The look of the grown tree can be controlled or customized by a user by setting a step or growth size for the branches. The smaller the step size the greater the resolution of direction changes on the branches (e.g., a branching will not occur between particle positions but, instead, at a branch particle position). A corresponding increase in other factors such as “trunk step factor” may result in a tree of similar size but greater complexity as it takes more frames to grow to the same height. Such control may also be provided with a rule/parameter 144 such as a branching control that set the frequency of branching such as by a value for frames between buds (or particles representing buds). Branch lengths and other rules or parameters for growing a tree may be set by a user in a selected and loaded template, and each setting will effect how a tree is modeled such as by setting the minimum or maximum length of a tree (e.g., by number of particles in the branch), by setting maximum height of a tree (e.g., by number of particle in the trunk or the like), and many other rules/parameters that affect how a tree is grown by the vegetation generator 136 as it evaluates the rules for each particle at each growth cycle using the particles' attributes 150.

Turning again to FIG. 2, the method 200 continues at 210 with creating a root particle or a “seed” or origin particle. The seed particle is created once on, the first frame or first time step in the growth process (e.g., the first growth cycle), and the seed particle is placed by a user at a given position in a 3D scene. The 3D scene may be retrieved as part of selecting a template or a scene may be selected from memory 140 (not shown in FIG. 1) or from another storage device accessible on the network 120. The particle is provided an identifier (such as bud or particle number “0” or the like) and all of its attributes are initialized and stored in memory 140 as shown at element 150. For example, the attributes for the seed particle may be initialized by reading parameters from the user interface panels that may have been populated by loading a pre-existing template 142 with parameters 144 or by a user interactively setting new values (or a combination thereof). In the first frame or growth step/cycle, the root particle is also a lead particle.

Steps 216 to 260 are performed by the vegetation generator 136 such as with module 138 for each frame or growth cycle. At 216, new lead particles are created, and, specifically, a new lead particle is created from all existing lead particles. Initially, each of these new lead particles has the same attributes (e.g., inherit all attributes from generator or parent particle) and 3D position as their respective generators. An existing lead particle generator can be: a root particle, a branch tip lead particle, and a trail particle, which has been converted into a bud node as the result of being assigned the “branch trigger” or “branch regeneration (or “regen”)” attributes. At 216, the parent or generator particle may have its attributes updated such as to store identifications of all children particles, and new or children particles may also include a reference or link to their parent and their parent's growth direction. At 220, the growth process 200 continues with updating intrinsic attributes 150 for all existing particles 148. A subset of attributes on all particles is typically designated as being “intrinsic,” and these intrinsic attributes are driven specifically by the current time step and are updated before all other attributes. An example of an intrinsic attribute is “frame age” of a particle regardless of the particle is a lead, trailing, or root particle, and other examples include growth accumulation and width. Step 220 (or another step such as step 240) may also include tagging certain of the newly generated particles for future branching (e.g., identifying the particle as a branch or “bud” particle), and after a particle is tagged for branching, an attribute may be incremented each growth cycle or frame to determine when branching should occur (e.g., a bud tag accumulation attribute has exceeded a particular value).

At 224, the method 200 includes checking all the branches of the plant or tree to see if an attribute indicating branch death has been triggered. If it has, step 224 includes deleting all particles in the dead branch (and all child branches of any of those particles). Also, any twigs or leaves that may have been attached to those particles would also be deleted from the 3D model of the plant or tree.

The generation method 200 continues at 230 with gathering of environmental data for use in evaluation growth rules 144 for an associated template 142. For each particle, the environment immediately surrounding the particle is analyzed by the growth module 138. This analysis includes looking for the presence of physical obstacles in 3D space as well as measuring the presence of tropism effectors such as light and moisture and dynamic forces such as wind. In the case of root system, an environmental factor for a particle in the root system may be the hardness of the surrounding soil and immovable obstacles. Measuring tropism effectors allows such attributes to be updated and accumulated for each particle, and the gathering at 230 may include looking at what effectors are present in the 3D space or environment (e.g., the simulated scene in which the tree or object is being grown) that would either promote or inhibit growth in a particular direction.

The tropism effectors are generally defined as part of the template and/or its rules that have to be evaluated for each particle. Tropism effectors detection may include checking position of neighboring particles within a defined radius and then generating a vector pushing away from them (but, typically, excluding particles within the same branch as determined by parent/child relationships or other stored attributes for the particle that may identify its branch membership), and this may be considered accounting for “interaction.”

Detecting physical obstacles is preferably part of gathering environmental data 230 for each particle. Physical obstacles within the 3D space or environment that are within the vicinity of the particle being considered are detected according to one embodiment by checking the position and determining the number of neighboring particles (of the tree being modeled and other trees growing nearby) that are located within a certain distance such as within a radius excluding those in the same branch. Determining physical obstacles may further include determining other physical objects, and this may be done by using ray tracing techniques. For example, rays may be shot out from the current particle (e.g., in a 360 degree pattern), and the rays will strike and bounce back to the particle from other objects such as virtual leaves and any other polygonal objects in the 3D space (such as natural structure provided in the model such as rocks, hillsides/cliffs, and the like and manmade structures provided in the model such as a building, a pole, a fence/trellis, and the like). The environmental data may then include information such as collision distances (or distances to nearby objects), collision directions (or relative location of located objects), and, in some cases, a direction to escape collision with other objects. The gathered or determined environment data may also include information such as location of shade (e.g., as determined by locating leaves or overhanging objects) that may be used to direct growth as most plants grow away from shade toward light.

The method 200 continues at 240 with calculating the direction of particle movement for lead non-bud particles, for lead bud particles, and for trailing particles. In this step 240, the determination of how much and where a particle is to be moved within the 3D space. In one embodiment, each of the particles is classified into one of three categories and a different algorithm or process is used for particle movement determination for each of these categories. The categories may be lead particles that are not bud nodes, lead particles that are bud nodes, and trail particles. In all three of these cases, the new, position of a particle is derived based on a set of input data, which may include environmental data gathered in step 230 concerning the virtual world or environment in which the plant is growing. The set of input data may also include user settings provided in the template rule set that controls how the plant should respond to specific environmental factors. User settings (or default settings) may also encode or define natural tendencies of a plant and may further allow or block randomness such as random variations to reduce a modeled tree that branches and/or grows too symmetrically or too predictably, which is atypical in nature. The input data also include attributes stored in memory and associated with each particle (e.g., stored “on the particle itself”).

An algorithm that may be thought of as a direction mixer is used to determine movement of the lead non-bud particles. The various environmental vectors (e.g., gathered data defined or stored as a vector to assist in directional calculations) are scaled by the user input parameters relating to the plant's sensitivity to a given environmental factor. For example, a user may set via the template in the user interface the plant's light sensitivity to a high value, and, as a result, the vector representing movement towards a light source will count more (e.g., be more heavily weighted) than if the light sensitivity was set at a lower value. A single environmental vector is then calculated and normalized. In one representative but not limiting example, this is performed by vector averaging of the Cartesian components of all the scaled input vectors. The resulting environmental vector along with a user randomization vector, if present, are used to weight the direction of growth given by the particle's parent particle. In other words, given no environmental inputs and no randomness, a lead particle would continue to follow or grow in the direction of growth inherited or indicted by its parent particle.

A branch angle algorithm may be used to determine movement direction for all lead bud particles. In this case, a determination is made of the angle of a new branch relative to the geometric vector of its parent bud node particle. Branches have a characteristic angle relative to their parent based on a user input value that corresponds to a given plant species (as is defined by the rules/parameters 144 of a chosen template 142 with or without user modification). The branch angle determination may be further complicated by the fact that multiple angles preferably are distributed evenly around an existing parent branch or trunk, and, thus, step 240 may be performed to consider a holistic view of the emanating branch. The presence of physical obstacles in the immediate neighborhood (e.g., within a particular radius or distance from the particle) as gathered in step 230 may be used to influence the resulting direction vector to at least avoid the obstacle and, in some cases, to grow away from the obstacle (e.g., move up to 90 degrees or more in direction away from the detected obstacle or its detected position).

For trail particles, the movement determination algorithm may be created to account for branch weight and/or branch death. For each particle, the process 240 includes marching up through all of its descendants from a parent to its children counting the total number as well as the number that are still flagged as alive (have an attribute that indicates that the particle is alive rather than dead). Each existing particle is then adjusted to accommodate the additional weight of new growth or the reduction in weight associated with loss of dead branches (or portions of branches). Other dynamic forces may also be applied in step 240 such forces and effects of gravity. The number of children of a particle is counterbalanced, in some cases, by the width and strength of the wood (or plant material) so that there may be no movement at all due to downstream branch weight (e.g., gravity effects) or movements only in initial life cycles of the plant, and the step 240 may be carried out such that horizontally of the growth direction scales or changes this gravity/weighting of a branch effect (e.g., the modeling may account for lever arm effects with a branch growing outward horizontally or less vertically being effected to a greater degree by weight of children particles or other parts of the branch than a similar branch growing at a more vertical direction).

The method 200 continues at 250 with moving particles in the model to their new positions in 3D space. The movement (or new position) is selected based on the movement vectors calculated in step 240. Both lead and trail particles are moved in this step; however, typically in the case of lead particles, additional attributes are updated (such as growth direction and distance from root), which may be an important influence on subsequent child particles in future time steps or growth cycles.

At 260, the 3D model of the tree, plant, or other object with a rigid body/skeleton is modified by updating in memory the dynamic attributes for all particles including limits, budding, twig attachment, and death. A subset of the attributes on all particles is designated as dynamic in some embodiments. These attributes are driven by combinations of user input and the current state of other particle's dynamic attributes at a given time step. Most dynamic attributes involve accumulating a value over multiple time steps or growth cycles, and, then, testing that value against a threshold which, when reached, causes the attribute to be marked as “triggered,” Examples of dynamic attributes are various growth limits, tags for budding nodes, tags for twig attachment, and branch death. Some important attributes that get updated in step 260 are called out below:

Step 260 may include tagging bud nodes. As new particles are processed, certain ones are tagged for future branching based on user values. A bud tag does not activate right away but is on a time delay that triggers at a later time step such as when the particle has become a trail particle. A bud node can ultimately spawn a single branch or multiple branches based on user settings as well as randomization parameters. Step 260 may also include tagging twig attachments. Twig attachment tagging is a variant of bud tagging. A subset of the particles with bud tags is designated as twig attachment points (e.g., for creating a branch at a certain frame age such as after three or more additional growth cycles). Instead of these trail particles spawning new lead particles, user designated L-System twig hierarchies are attached according to the branch angle. Step 260 may further include performing growth limits testing. In this case, lead particles are tested against user input limits (such as a maximum vertical size of the plant). Limits can be either soft limits or hard limits. Soft limits will permit new lead particles to be generated but outward movement will be greatly slowed, whereas hard limits will cause a lead particle to become a trail particle and effectively stop any further growth of its branch in the future. Additionally, step 260 may include death testing. Trail particles, in this process, are tested against conditions such as whether they should become a budding node or whether they should be flagged as dying off. Note that, in some embodiments, trail particles that are bud nodes can lose their child branches at one time step but then have them regenerated again at a future time step (e.g., periodically bud nodes may be tested for shadow and/or proximity attributes to determine when it is appropriate/desirable per the template to bud new branches). Additionally, the process 260 may include marching downward through the particles from child particles to the parent particle in order to determine which branches are alive and which are not. Once any particle on a branch has stopped growing, in one embodiment, all particles on that branch are tagged as dead. If they have been dead for a certain length of time or number of growth cycles or frames, the particles are removed from the model in the next time step (e.g., in step 224 of the next iteration), e.g., a branch that is dead may eventually fall off the 3D model of the tree or plant. At step 270, a determination is made whether there should be additional growth cycles or frames such as when the preset growth age has not yet been reached. If not, the method 200 ends at 290, and if yes, the method 200 continues iteratively at step 216.

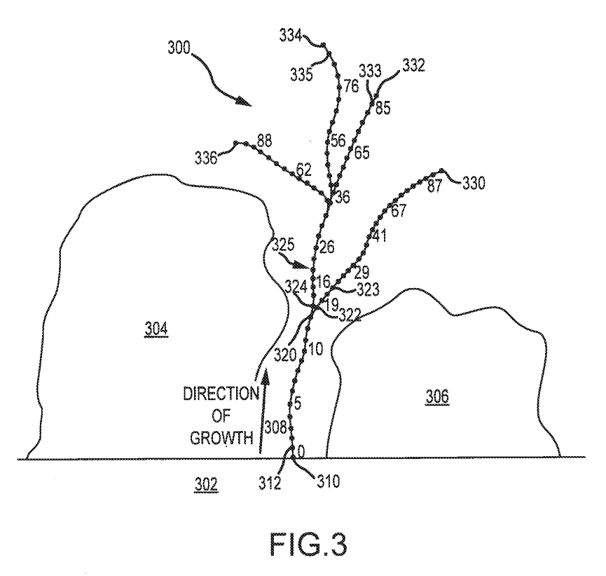

FIG. 3 illustrates an exemplary 3D model 300 of a tree (or a representation of such a model that may be displayed on a user interface or monitor after or during a growth process of the invention). The tree 300 represents a particle-based model that can be grown by using the method 200. As shown, the tree 300 was grown by positioning a seed or root particle 310 at a location on the top of soil 302 between two physical obstacles 304, 306 (e.g., rocks in this example but could be nearly any physical structure) provided in the 3D environment or space. To produce or generate the tree 300, a template was selected and control rules/parameters set (e.g., an amount of randomness allowed) as discussed above. The tree 300 includes a plurality of particles that are represented with dots in FIG. 3, and the particles are identified with numbers (with only a subset of the numbers being shown to ease representation of the tree 300) associated with when they were created. For example, the particle 312 was the particle created from seed particle 310 in an initial growth cycle or frame/step and its position generally followed an assigned direction of growth (e.g., in the direction inherited from the seed 310 but effected by randomness and environmental factors).

As shown, the tree 300 has undergone numerous grown cycles (e.g., 40 to 50 or more cycles or steps), and branching has occurred as well as growth including creation of new particles, gathering environmental date evaluating template rules to determine positions for all particles, and movement of particles. For example, branching occurred at particle 320 with the creation of two new particles 322, 324, and one of these continued the trunk 325 (which may also be considered a branch) while the other 322 created a new branch 323. The branch 323 beginning with particle 322 grew in a direction that was selected based on environmental data and, particularly, the position of the obstacles 304 and 306 with the branch 323 growing away from obstacle 304 and vertically or at angle above obstacle 306. Later, branching occurs above the obstacle 304 with branch including lead particle 336. The trunk (or another branch) 325 continues upward with lead particle 334 followed by a plurality of trail particles including particle 325. An additional branch is formed that includes lead particle 332 with trail particles including particle 333. As discussed earlier, the particles of the branches of tree 300 are processed during each growth cycle or frame to gather environmental data and this may include the location of neighboring particles in the tree 300 and when a direction of movement or growth is determined it may involve growing toward a less crowded position in the 3D space (e.g., away from neighboring particles as well as away from physical obstacles 304, 306).

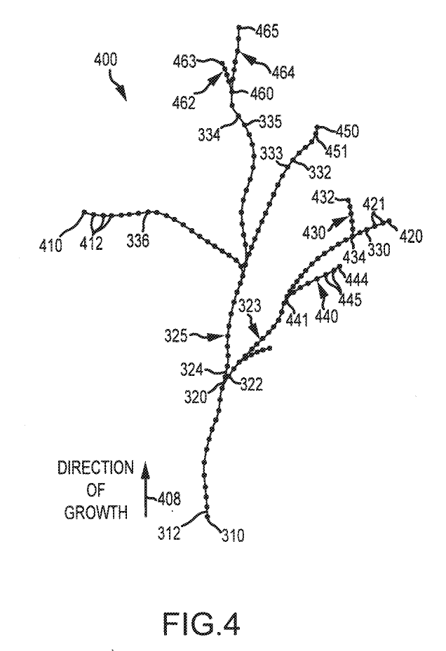

FIG. 4 illustrates a tree 400 modeled by growing the tree 300 of FIG. 3 through an additional number of growth cycles or time steps (such as about 7 additional steps). As shown, the direction of growth 408 is still generally vertical and a number of branches have been automatically created by the vegetation generation method (e.g., method 200 as may be implemented by system 100). For example, in branch 323, branches 430 with lead particle 432 has branched off at particle 434 while prior lead particle 330 has generated trail particles 421 and new lead particle 420 for branch 323. Also at particle 441., branch 440 has grown with present lead particle 444 and trail particles 445. In other side branches, particles 332 and 336, which were lead particles in tree 300 are now trail particles and have been used to form (are parents of) lead particles 450, 410 and trail particles 451, 412. In the main trunk or branch 325, the lead particle 334 of tree 300 has been used to create new particles with branching at trail particle 460 into two branches 462, 464 with lead particles 463, 465. The growth of tree 400 from tree 300 occurs automatically through execution of process 200 of FIG. 2, such as through 7 or more additional growth cycles and this additional growth/aging can be controlled by an operator or user of the vegetation generator of the invention.

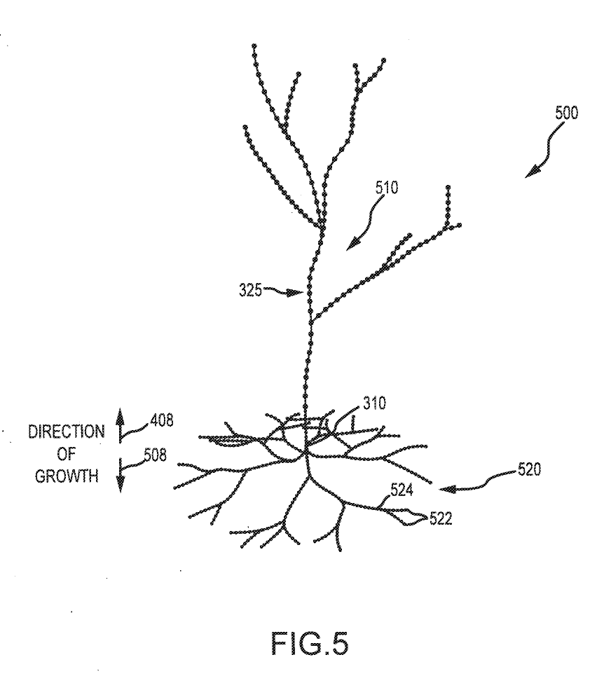

FIG. 5 illustrates a 3D model 500 of a tree using the particle-based vegetation techniques described herein. In this example, the model 500 generally includes the tree 400 of FIG. 4 grown in an upward direction 408 through a plurality of time steps or frames (e.g., 40 to 50 steps). Concurrently, a direction of growth 508 that was downward was input to the template chosen to grow model tree 500 to create a root structure or system 520 from the seed or root particle 310. As shown, the root structure 520 is similar to the tree structure 400 in that branches are created by the iterative creation of new particles, of gathering environmental data, of calculating a movement direction based on the environmental data (e.g., by evaluating growth rules using the data as input parameters and the like), and of moving the new particles to positions in 3D space based on the calculated directions. The root structure typically is designed to grow more slowly (e.g., amount of movement per frame or time step is less) to account for the characteristics of roots and environment such as hardness of soil. Again, lead particles 522 are provided at the end of the root structure 520 (at root tips) while these are followed on root “branches” by trail particles 524, which are parents to the lead particles 522 (and the lead particles 522 are child particles to trail particles 524).

FIG. 6 illustrates a 3D model 600 of a tree in which a texture has been applied such as by operation of texture, bark generator 168 or an editing/tuning module 172 has been used to apply or modify the applied bark and/or tree structure. As shown, the tree model 600 is built upon the rigid structure or skeleton provided by particle-based tree model 400 of FIG. 4. Upon the structure of model 400, a skin or bark 610 has been applied or used to envelope the model 400. As discussed previously, the bark 610 may be applied in part by retrieving information provided in the attributes for the particles. This data may include growth of direction 408 for one or more of the particles to facilitate providing the bark with a proper orientation throughout the tree 600.

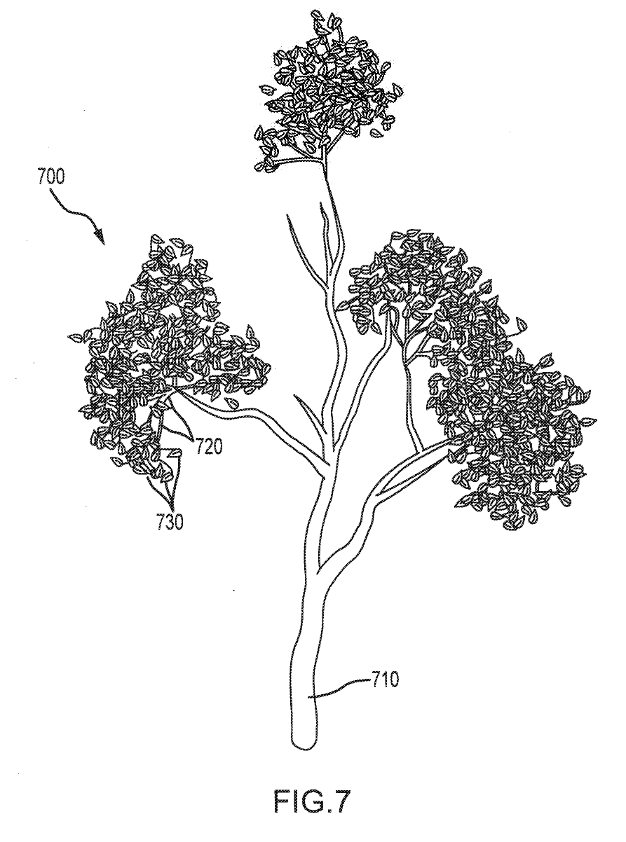

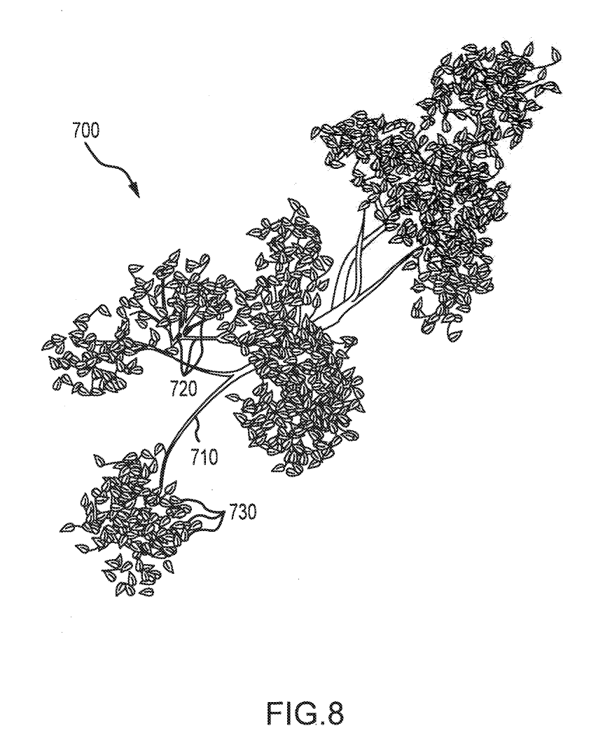

FIGS. 7 and 8 illustrate a 3D model 700 of a tree showing a front or side view as well as a top view. The rigid trunk and branch structure of the tree 710 may be the tree 600 or the tree 600 after it has been further aged through a number of additional time steps or growth cycles. The model 700 may be formed in part by an operator retrieving the tree structure or 3D model 710, selecting a number of locations (i.e., particles) for twig generation, and then using a tool such as twig generator 160 to grow the twigs or twig structures/systems 720. In some cases, the twigs 720 are located at particles in the tree model 710 that have a twig location attribute assigned to them or turned “on” while in other cases the location is performed manually. If performed automatically, an editing module, such as module 172, may be used by an operator of the workstation 110 or system 130 to delete, modify, move, and/or copy the twigs 720 as part of a tuning of the model 7000. The particle-based tree model 710 may be used with twig systems 720 that are L-systems or other non particle-based models. After the twigs 720 are created, leaves 730 may be grown and/or attached to some or all of the twig ends 720 such as with another tool like the leaf generator 164. It may be useful in some embodiments to attach twigs 720 and leaves 730 during the growth process 200 such that these structures are identified during the gathering of environmental data (e.g., during ray casting or by other techniques) so as to provide another “natural” influencing factor for determining on a particle basis growth direction for the tree 710.

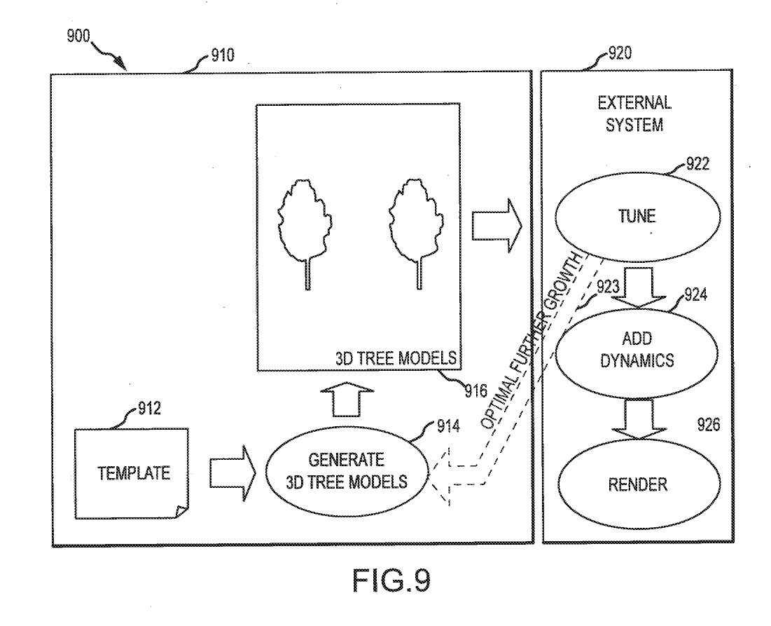

FIG. 9 illustrates schematically a particle-based vegetation generation process 900 in which a procedural vegetation system 910 (e.g., a computer system running computer software/code provided in readable medium) works in conjunction with an external animation system 920 (e.g., a computer system running software/code provided in readable medium). As shown, the process 900 begins with the procedural vegetation system 910 creating or retrieving from memory (or from another source on a network or the like) a template 912. The template includes the rules and/or parameters that control growth of the particular species of vegetation and may set a number of limits and growth actions to take in response to detection of particular environmental data for a particle. The process 900 continues with the system 910 generating 3D tree models at 914 and the generated 3D models 916 may be stored in memory. The generation 914 typically will be performed by a module(s) according to a growth algorithm such as shown in FIG. 2 and will include creating new particles in each growth cycle or time step from each lead particle (with inheritance of parent attributes), detection of environmental data for each of these particles and for other live particles, determination of a growth direction by evaluating the rules of the template with the gathered data (e.g., location of obstacles, proximity and number of neighboring particles, location of light/shade, and the like), and moving the new and previously existing particles to new locations based on the determined movement direction.

Interestingly, each of the particles of the 3D model of the tree or other vegetation includes stored information or attributes, and this information and the form of the 3D model 916 allows it to be readily transferred (e.g., via a network via access to a shared storage device, or the like) to the external system 920 for further processing/use. As shown at 922, one or more of the 3D models 916 are tuned or edited. This may include moving branches, changing the length, shape, width, or other features of the tree. The model may optionally than be transmitted at 923 for further growth/generation at 914, e.g., a modified particle-based 3D model of a tree may be further aged through a user-selected number of additional time steps or growth cycles. At 924, the external system 920 may add dynamics and then at 926 the generated 3D model, which typically has been enveloped in bark, had twigs attached, and leaves grown on the twigs such as by modules in the vegetation system 910, is rendered by the external system 920 to produce a rendered image for use in an animated image (e.g., the rendered image can be used as a composite level of a frame of an animated film or the like).

With the above description in mind, it may be useful for more fully understanding the particle-based vegetation generation method (such as method 200) to provide further discussion of how the attributes associated with each particle change during the growth of a modeled object (e.g., change over the time steps or growth cycles). The following discussion provides an illustration in which a small subset of possible particle attributes on or associated with a particle is described and shown to change over three time steps (or growth cycles). Of course, many more attributes may be provided for each particle in a number of various categories to facilitate growing vegetation in which each particle is aware of and its growth is influenced by the environment and inherited characteristics (as well as the user-selected template rules/parameters),

Exemplary intrinsic attributes, with attributes marked with “*” that are updated on new particles only, may include:
*particle_id—Identifier of the particle
*parent_id—Identifier of the particle's parent
*parent_direction—Vector representing growth direction of the particle's parent
frame_age—Number of time steps that a particle has been alive
bud_frame—Time step at which particle last gave birth to branches
*birth_position—Position in 3D space where the particle was born
*growth_direction—Vector representing growth direction when the particle was born

Exemplary dynamic attributes that are updated on all particles may include:
light_amount—Amount of light hitting particle
shade_escape_direction—Direction to escape shadow
bud_trigger—Delay timer that activates a particle already tagged as a bud to give birth to branches
is_bud—Tag which designates a particle as a bud node
bud_branch_count—Number of branches that will be birthed from a bud node

For this example, it is assumed the following settings (e.g., “growth rules/parameters” used with gathered environmental data for each particle to determine growth direction and the like) have been set via a rule template displayed in a user interface. In some embodiments, these settings are animated (e.g., to change) over time, but in this example, it is assumed that they are static values:

Plant property settings:
bud_frequency=1.0
bud_branches=2
light_sensitivity=0.5
   Environment settings:
light_direction=−0.6, −0.6, 0
number_of_rays=50
ray_length=5000

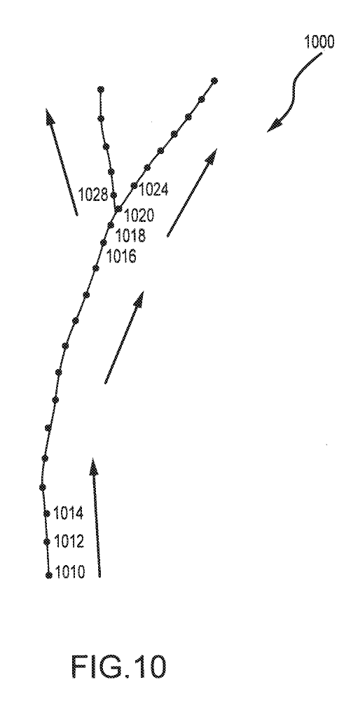

In this example, we are tracking a particle system (such as a tree structure or 3D model of a tree or other plant), shown as 1000 in FIG. 10, until it grows to include 17 or more particles. From time steps 1 through 15, the algorithm handles a single new lead particle at each step as the particles grow up more or less linearly from the root or seed particle 1010 to particle 1012, 1014 and so on to particles 1016, 1018, tending towards the light source which was specified in the user interface by input into a template. Then, at time step 15, particle labeled 1020 in FIG. 10 (and as “14” in the tables) gets a value in attribute bud_trigger that exceeds the user specified threshold of 1 (bud_frequency shown above) thus causing a branching event. At time step 16, the algorithm is now dealing with two new lead particles in parallel, particles 1024 and 1028.

The description below is a step by step breakdown of how the subset of attributes are updated at the various stages of the algorithm (e.g., the process 200 shown in FIG. 2). Any lead particle will initially be cloned from its parent particle. In time step 1 of this example, the particle is cloned from the root particle. All attributes below are marked with “*” to indicate that they are only updated for new particles.

TABLE 1
Create New Lead Particles

| | T 1 | T 2 | T 3 | | T 15 | T 16 | T 16 | T 16 |
|---|---|---|---|---|---|---|---|---|
| Attribute | (1010) | (1012) | (1014) | . . . | (1020) | (1020) | (1024) | (1028) |
| *particle_id | 0 | 1 | 2 | | 14 | N/A | 15 | 15 |
| *parent_id | 0 | 0 | 1 | | 13 | N/A | 14 | 14 |
| *parent_direction | 0, 0, 0 | 0, 0, 0 | 0, 1, 0 | | 0.7, 0.6, −0.7 | N/A | 0.6, 0.5, −0.7 | 0.6, 0.5, −0.7 |
| *frame_age | 0 | 1 | 2 | | 14 | N/A | 15 | 15 |
| *bud_frame | 0 | 0 | 0 | | 0 | N/A | 0 | 0 |
| *birth_position | 0, 0, 0 | −0.3, 1, 0.1 | −0.5, 2, 0.1 | | 3.7, 14.8, −0.5 | N/A | 4.6, 15.2, −5.2 | 4.6, 15.2, −5.2 |
| *growth_direction | 0, 1, 0 | −0.3, 1, 0.1 | −0.6, 0.5, 0 | | 0.6, 0.6, 0.5 | N/A | 0.6, 0.5, −0.4 | 0.6, 0.5, −0.4 |
| *light_amount | 1 | 1.5 | 1.5 | | 4.2 | N/A | 4.2 | 4.2 |
| *shade_escape_direction | 0, 0, 0 | 1, 0.3, −0.5 | 0.9, 0.4, −0.5 | | 0.8, 0.1, −0.6 | N/A | 0.7, 0.3, −0.7 | 0.7, 0.3, −0.7 |
| *bud_trigger | 0 | 0 | 0 | | 0 | N/A | 0 | 0 |
| *is_bud | 0 | 0 | 0 | | 0 | N/A | 0 | 0 |
| *bud_branch_count | 0 | 0 | 0 | | 0 | N/A | 0 | 0 |

TABLE 2
Update Intrinsic Attributes for All Particles

| | T 1 | T 2 | T 3 | | T 15 | T 16 | T 16 | T 16 |
|---|---|---|---|---|---|---|---|---|
| Attribute | (1010) | (1012) | (1014) | . . . | (1020) | (1020) | (1024) | (1028) |
| *particle_id | 1 | 2 | 3 | | 15 | N/A | 16 | 17 |
| *parent_id | 0 | 1 | 2 | | 14 | N/A | 15 | 15 |
| *parent_direction | 0, 0, 0 | 0, 1, 0 | −0.6, 0.5, 0 | | 0.6, 0.5, −0.7 | N/A | 0.6, 0.5, −0.4 | 0.6, 0.5, −0.4 |
| frame_age | 1 | 2 | 3 | | 15 | 16 | 16 | 16 |
| bud_frame | 0 | 0 | 0 | | 0 | 15 | 0 | 0 |

In Table 2, attributes marked with * are only updated for new particles. The other attributes are updated for all particles. The step shown in Table 2 typically is followed by removing any dead branches.

TABLE 3
Gather Environmental Data

| | T 1 | T 2 | | | T 15 | | T 16 | T 16 |
|---|---|---|---|---|---|---|---|---|
| Attribute | (1010) | (1012) | T3 (1014) | . . . | (1020) | T 16 (1020) | (1024) | (1028) |
| light_amount | 1.5 | 1.5 | 1.4 | | 4.1 | 4.2 | 4.3 | 4.1 |

TABLE 4
Calculate Direction of Particle Movement

| | T 1 | T 2 | T 3 | | T 15 | T 16 | T 16 | T 16 |
|---|---|---|---|---|---|---|---|---|
| Attribute | (1010) | (1012) | (1014) | . . . | (1020) | (1020) | (1024) | (1028) |
| shade_escape_direction | 1, 0.3, −0.5 | 0.9, 0.4, −0.5 | 0.3, 0.4, −0.2 | | 0.7, 0.3, −0.7 | 0.7, 0.3, −0.7 | 0.6, 0.3, −0.6 | 0.7, 0.3, −0.1 |

TABLE 5
Move Particles

| | T 1 | T 2 | | | T 15 | T 16 | T 16 | T 16 |
|---|---|---|---|---|---|---|---|---|
| Attribute | (1010) | (1012) | T 3 (1014) | . . . | (1020) | (1020) | (1024) | (1028) |
| *birth_position | −0.3, 1, 0.1 | −0.5, 2, 0.1 | −0.7, 2.8, 0.3 | | 4.6, 15.2, −5.2 | N/A | 5.6, 17, −5.2 | 4.1, 16.8, −6.4 |
| *growth_direction | −0.3, 1, 0.1 | −0.6, 0.5, 0 | −0.7, 0.7, −0.8 | | 0.6, 0.5, −0.4 | N/A | 0.6, 0.5, −0.3 | −0.8, 0.2, −0.7 |

Attributes marked with “*” in Table 5 are only updated for new particles.

TABLE 6
Update Dynamic Attributes for all Particles (Including Limits, Budding, Twig
Attachment, and Death)

| | T 1 | T 2 | T 3 | | T 15 | T 16 | T 16 | T 16 |
|---|---|---|---|---|---|---|---|---|
| Attribute | (1010) | (1012) | (1014) | . . . | (1020) | (1020) | (1024) | (1028) |
| bud_trigger | 0.1 | 0.1 | 0.3 | | 1.1 | 0 | 0.1 | 0.1 |
| is_bud | 0 | 0 | 0 | | 1 | 1 | 0 | 0 |
| bud_branch_count | 0 | 0 | 0 | | 2 | 2 | 0 | 0 |

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, some embodiments of the invention include a selectable option by a user to grow a simplified tree (or other plant/object). For example, simplified trees may be useful for enhancing processing speed by reducing the overall number of particles that are used to represent a tree, which reduces the number of branches and later the number of branches, twigs, and leaves required for the rendered tree. To this end, the tree may be simplified by placing an “object” or user definable physical obstacle within the simplified tree. More particularly, a user may choose to grow a tree and place a sphere (or other shaped object) a particular distance above the location of the seed particle. In this manner, the tree structure grows upward and around the sphere/physical obstacle to create a detailed tree structure that is “hollow” or has no internal detail such as branches and the like. The fact that the tree is hollow will not readily be detectable if the tree is used as a background object rather than a foreground tree, and, hence, the intentional use of obstacles within a growth path of a tree is effective in creating realistic but simplified 3D models of trees (and other plants). The GUI may include a slide bar or other selection tool that allows a user to pick the complexity of the model for a new tree or plant such as from low to medium to high, and the size/location of the physical obstacle may be automatically selected based upon this setting (e.g., no sphere for high complexity, a smaller sphere for medium complexity, and a relatively large sphere for low complexity or the like).

As will be understood from the above description, the templates allow an animator or modeler to select a template from memory that provides growth rules to achieve a simulation of a particular species of plant. The template may also include a number of parameters that are used to pass attributes or “DNA” to the seed or root particle, and this DNA is passed to or inherited by each subsequently created particle (e.g., allows passing appearance data and other information). But, each particle is not identical as the particles change over time due to the collection of environmental data that may be unique to that particular particle (e.g., the particles are self-aware) and other attributes such as age distinguish them from other particles (which may effect width of an associated skin/bark, its growth rate as older particles typically grow or move more slowly depending on the particular growth rules, and the like). Ray tracing or occlusion awareness is provided for each particle, too, which allows the particles to be self-aware and to grow differently compared with other particles (e.g., each particle tries to avoid obstacles that may only effect portions of the tree/model). The use of a particle system or structure to model a tree/plant allows the particle system to be readily modified or manipulated after a number of growth cycles such as by artistic grooming to achieve a desired (but not necessarily “natural”) look, and then the modified tree, may be exposed to further growth using the particle-based vegetation generation techniques described herein.

We claim:

1. A computer-based method for generating a rigid geometric model, comprising:
providing a template in memory comprising a set of growth rules for the geometric model;
positioning with a computer processor a base particle in a location in digital three dimensional space, wherein the base particle is associated with a set of attributes stored in the memory with at least a portion being provided by the template; and
running a generator module with the computer processor to generate the geometric model using particle-based growth from the base particle, wherein the particle-based growth comprises iteratively generating additional particles, gathering environmental data for the particles, and moving each of the particles within the three dimensional space based on an evaluation of the growth rules using the gathered environmental data and the set of attributes.

2. The method of claim 1, wherein the three dimensional space comprises at least one physical obstacle to growth, wherein the gathered environmental data for at least one of the particles comprises identifying a relative location of the at least one physical obstacle, and the moving for the at least one of the particles comprises selecting a direction in the three dimensional space away from the location of the at least one physical obstacle.

3. The method of claim 1, wherein the gathered environmental data for each of the particles comprises data on other ones of the particles within a predefined proximity and wherein the moving each of the particles comprises determining a direction of movement in the three dimensional space based on the data on the other particles in the predefined proximity.

4. The method of claim 1, wherein the generating, the gathering, and the moving of the particle-based growth are performed for a number of time steps, whereby the gathering of the environmental data is performed during each of the time steps for substantially all of the particles and each of the substantially all of the particles is moved during each of the time steps based on temporally collected data in the three dimensional space.

5. The method of claim 1, wherein the geometric model comprises a three dimensional model of a plant, the gathering of the environmental data comprises measuring tropism, effectors, and the moving comprises determining a direction of particle movement based on the tropism effectors on a particle-by-particle basis.

6. The method of claim 5, wherein the particles include a lead particle and a set of trail particles associated with the lead particle and wherein the gathering of environmental data and the moving of the particles are performed for the lead particle and for the trail particles, whereby at least some of the trail particles are moved during the moving of the particles during the particle-based growth.

7. The method of claim 5, wherein the set of attributes comprises an attribute indicating death of a particle and wherein the particle-based growth comprises periodically deleting dead ones of the particles along within a set of the particles defined by the set of attributes as children of the dead particles.

8. The method of claim 5, wherein the set of attributes comprises an attribute indicating whether a particle is a bud or non-bud particle and wherein the particle-based growth comprises for at least some of the bud particles generating a branch including a lead particle.

9. A computer readable medium for generating digital 3D models of plants for use in animation, comprising:
computer readable program code devices configured to cause the computer to effect retrieving a set of growth rules for a plant;
computer readable program code devices configured to cause the computer to effect providing a set of particles each with an associated set of attributes including a unique location in a 3D space; and
computer readable program code devices configured to cause the computer to effect generating a model of the plant in the 3D space from the set of particles including performing a predefined number of time steps;
wherein for each of the time steps, the model generating comprises gathering environmental data including measuring tropism effectors and detecting physical objects for substantially all of the particles, calculating a direction of particle movement for the substantially all of the particles on a particle-by-particle basis comprising evaluating the growth rules using the gathered environmental data, and moving the substantially all of the particles to new locations in the 3D space.

10. The computer readable medium of claim 9, wherein the detecting of the physical objects comprises transmitting rays from each of the substantially all of the particles.

11. The computer readable medium of claim 9, wherein the model generating comprises updating the set of attributes including providing the new locations and incrementing an age of the particle.

12. The computer readable medium of claim 11, wherein a death indication is included in the set of attributes and wherein the model generating comprises removing ones of the particles from the model based on a value of the death indication.

13. The computer readable medium of claim 9, wherein the measured tropism effectors include light in the 3D space and the calculating of the direction of particle movement comprises selecting a direction-toward the light.

14. The computer readable medium of claim 9, wherein the set of attributes includes an attribute defining the particle as a lead or a trail particle and as a, bud or non-bud particle, and wherein the model generating comprises moving the lead and the trail particles and at least for some of the bud particles generating a new lead particle from the at least some of the bud particles to form a new branch of the plant.

15. A computer-based method for generating a three dimensional (3D) model of a tree from a seed particle described by a set of attributes, comprising:
with a computer, displaying a representation of a 3D space on a monitor;
from an I/O device, receiving first user input positioning the seed particle at a location in the 3D space;
with the computer, creating a lead particle from the seed particle including inheriting the set of attributes from the seed particle;
gathering environmental data for the lead particle from the 3D space;
with the computer, moving the lead particle to a new location in the 3D space relative to the seed particle based on the gathered environmental data; and
for a predefined number of growth cycles using the lead particle, operating the computer to:
create new lead particles;
update intrinsic attributes in the set of attributes of all the particles;
gather environmental data in the 3D space for each of the particles.
calculate a direction of particle movement for the lead particles and for particles identified as trail particles based on the gathered environmental data; and
move each of the particles except the seed particle to a new location in the 3D space based on the direction of particle movement and the set of attributes associated with each of the particles.

16. The method of claim 15, wherein the gathering of the environmental data in the 3D space for each of the particles comprises performing ray casting from the particles to identify obstacles in the 3D space.

17. The method of claim 15, wherein the calculating of the direction of particle movement comprises using the gathered environmental data to evaluate a set of growth rules retrieved by the computer from memory for the tree.

18. The method of claim 17, wherein the gathering of the environmental data in the 3D space for the particles comprises measuring tropism effectors on a particle-by-particle basis and the growth rules are adapted to use the measure tropism effectors to at least in part define the direction of particle movement.

19. The method of claim 15, further comprising storing the particles and the set of attributes associated with each of the particles in memory as the 3D model of the tree, retrieving the 3D model of the tree from memory and attaching a twig structure to at least one of the particles, and applying leashes to at least some twigs in the twig structure.

20. The method of claim 19, further comprising modifying the 3D model of the tree with an editing module to generate a modified 3D model of the tree and repeating the operating of the computer to create, update, gather, calculate, and move for an additional number of the growth cycles with the modified 3D model of the tree.

21. The method of claim 15, wherein the steps of creating a lead particle from the seed particle, gathering environmental data for the lead particle, moving the lead particle to a new location, and operating the computer are performed in an upward direction and in a downward direction to create the tree and a root structure for the tree.
